(19) United States
(12) Patent Application Publication
(10) Pub. No.: US 2022/0232514 A1
(43) Pub. Date: Jul. 21, 2022

(54) UE GROUPING FOR PAGING ENHANCEMENT

(71) Applicant: MEDIATEK INC., Hsin-Chu (TW)

(72) Inventors: Li-Chuan Tseng, Hsin-Chu (TW); Wei-De Wu, Hsin-Chu (TW)

(21) Appl. No.: 17/542,405

(22) Filed: Dec. 4, 2021

Related U.S. Application Data
(60) Provisional application No. 63/137,777, filed on Jan. 15, 2021.

(51) Int. Cl. H04W 68/00; H04W 60/00; H04W 52/02

(52) U.S. Cl. CPC H04W 68/005; H04W 52/0209; H04W 60/00

(57) ABSTRACT

A method of providing paging early indication (PEI) for power consumption enhancements in a 5G/NR network is proposed. In accordance with one novel aspect, UE subgrouping is used to indicate whether some UEs (a subgroup) among those UEs monitoring the same paging occasion needs to read paging. The UE subgroup can be grouped based on different factors, e.g., power consumption profiled (PCP), or paging probability. The UE subgroup has a reduced number of UEs, with a reduced false alarm rate for paging, at thus a reduced power consumption. In one preferred embodiment, the PEI contains a bitmap, each bit indicates if a subgroup of UEs monitoring the same PO needs to read paging.

### CROSS REFERENCE TO RELATED APPLICATION

This application claims priority under 35 U.S.C. § 119 from U.S. Provisional Application No. 63/137,777 entitled “UE Grouping for Paging Enhancements UE Power Saving,” filed on Jan. 15, 2021, the subject matter of which is incorporated herein by reference.

### TECHNICAL FIELD

The disclosed embodiments relate generally to wireless communication systems, and, more particularly, to power efficient paging mechanism enhancement with paging early indication (PEI).

### BACKGROUND

Third generation partnership project (3GPP) and 5G New Radio (NR) mobile telecommunication systems provide high data rate, lower latency and improved system performances. In 3GPP NR, 5G terrestrial New Radio (NR) access network (includes a plurality of base stations, e.g., Next Generation Node-Bs (gNBs), communicating with a plurality of mobile stations referred as user equipment (UEs). Orthogonal Frequency Division Multiple Access (OFDMA) has been selected for NR downlink (DL) radio access scheme due to its robustness to multipath fading, higher spectral efficiency, and bandwidth scalability. Multiple access in the downlink is achieved by assigning different sub-bands (i.e., groups of subcarriers, denoted as resource blocks (RBs)) of the system bandwidth to individual users based on their existing channel condition. In LTE and NR networks, Physical Downlink Control Channel (PDCCH) is used for downlink scheduling. Physical Downlink Shared Channel (PDSCH) is used for downlink data. Similarly, Physical Uplink Control Channel (PUCCH) is used for carrying uplink control information. Physical Uplink Shared Channel (PUSCH) is used for uplink data. In addition, physical random-access channel (PRACH) is used for non-contention-based RACH.

One important use of broadcast information in any cellular systems is to set up channels for communication between the UE and the gNB. This is generally referred to as paging. Paging is a procedure the wireless network uses to find out the location of a UE, before the actual connection establishment. Paging is used to alert the UE of an incoming session (call). In most cases, the paging process happens while UE is in radio resource control (RRC) idle mode. This means that UE has to monitor whether the networking is sending any paging message to it and it has to spend some energy to run this “monitoring” process. During idle mode, a UE gets into and stays in sleeping mode defined in discontinuous reception (DRX) cycle. UE periodically wakes up and monitors PDCCH to check for the presence of a paging message. If the PDCCH indicates that a paging message is transmitted in a subframe, then the UE demodulates the paging channel to see if the paging message is directed to it.

In NR, paging reception consumes less than 2.5% of the total power. However, due to synchronization signal block (SSB) transmission scheme in NR, LOOP operations (including AGC, FTL, and TTL) and measurements (MEAS) can only be performed in certain occasions. As a result, the gap between the SSBs for LOOP/MEAS and paging occasion (PO) is longer, and UE may enter light sleep mode in the gap. A paging early indication (PEI) is introduced for power consumption enhancements in a 5G/NR network. PEI is provided to UE before paging and UE monitors PO only if paging is indicated by the PEI. As a result, UE can save power consumption not only for paging reception, but also for the light sleep between the last SSB and PO gap. Furthermore, since the power consumption profile (PCP) and the paging probability of each UE can be very different, additional power saving enhancements can be achieved if the PEI can be provided to subgroups of UEs based on their PCP and paging probability.

### SUMMARY

A method of providing paging early indication (PEI) for power consumption enhancements in a 5G/NR network is proposed. In accordance with one novel aspect, UE subgrouping is used to indicate whether some UEs (a subgroup) among those UEs monitoring the same paging occasion needs to read paging. The UE subgroup can be grouped based on different factors, e.g., power consumption profiled (PCP), or paging probability. Not every factor needs to be considered in each PEI group set, but more than two factors are allowed for UE subgrouping The UE subgroup has a reduced number of UEs, with a reduced false alarm rate for paging, at thus a reduced power consumption. In one preferred embodiment, the PEI contains a bitmap, each bit indicates if a subgroup of UEs monitoring the same PO needs to read paging.

In one embodiment, a UE performs registration in a wireless communication network. The UE belongs to a paging subgroup. The UE receives system information that comprises a paging early indication (PEI) configuration associated with a corresponding paging frame (PF). The UE monitors a PEI on a PEI-carrying radio frame based on the PEI configuration. The PEI indicates whether there is a paging opportunity (PO) in the corresponding PF for paging subgroups. The UE determines whether the PEI indicates positive paging for the paging subgroup that the UE belongs to. The UE monitors the PO in the corresponding PF when the PEI indicates positive paging.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates paging reception with paging early indication (PEI) and UE grouping for power saving enhancement in a 5G New Radio (NR) network in accordance with one novel aspect.

FIG. 2 is a simplified block diagram of a UE and a base station in accordance with various embodiments of the present invention.

FIG. 3 illustrates the concept of providing PEI for UE paging subgrouping for idle-mode power saving in accordance with one novel aspect.

FIG. 4 illustrates a preferred embodiment of providing PEI for UE paging subgrouping for idle-mode power saving in accordance with one novel aspect.

FIG. 5 illustrates a sequence flow between a UE and network entities supporting a first embodiment of UE paging subgrouping using PEI.

FIG. 6 illustrates a sequence flow between a UE and network entities supporting a second embodiment of UE paging subgrouping using PEI.

FIG. 7 is a flow chart of a method of UE paging subgrouping for power consumption enhancements in a 5G/NR network in accordance with one novel aspect of the present invention.

### DETAILED DESCRIPTION

Reference will now be made in detail to some embodiments of the invention, examples of which are illustrated in the accompanying drawings.

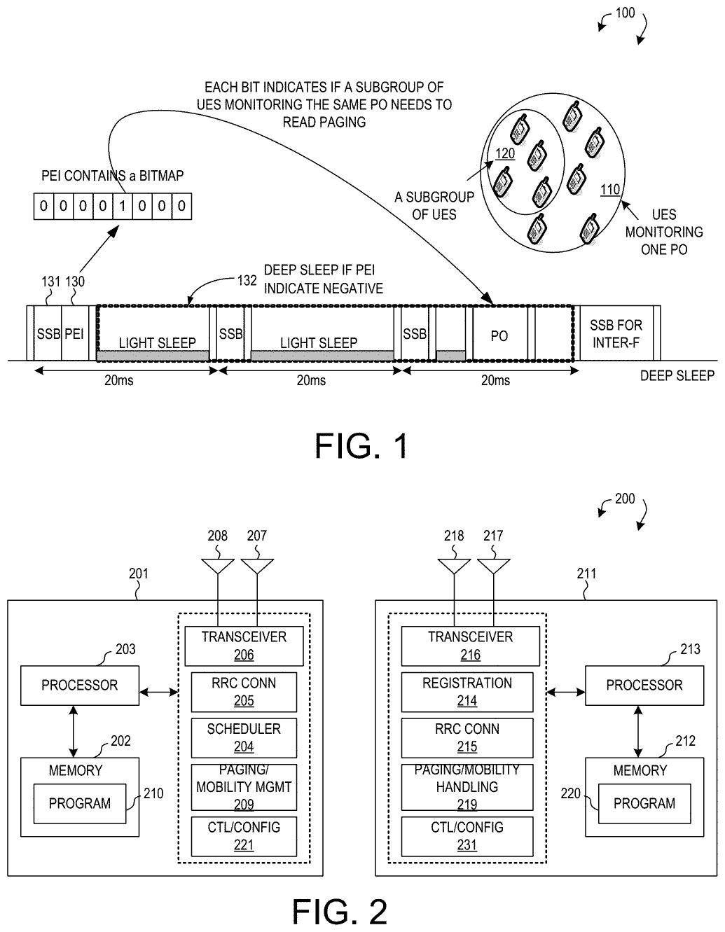

FIG. 1 illustrates paging reception with paging early indication (PEI) and UE grouping for power saving enhancement in a 5G New Radio (NR) network 100 in accordance with one novel aspect. In 3GPP NR, 5G NR access network (a plurality of base stations, e.g., Next Generation Node-Bs (gNBs), communicating with a plurality of mobile stations referred as user equipment (UEs). Orthogonal Frequency Division Multiple Access (OFDMA) has been selected for NR downlink (DL) radio access scheme due to its robustness to multipath fading, higher spectral efficiency, and bandwidth scalability. In both LTE and NR networks, Physical Downlink Control Channel (PDCCH) is used for downlink scheduling. Physical Downlink Shared Channel (PDSCH) is used for downlink data. Similarly, Physical Uplink Control Channel (PUCCH) is used for carrying uplink control information. Physical Uplink Shared Channel (PUSCH) is used for uplink data. In addition, physical random-access channel (PRACH) is used for non-contention-based RACH.

One important use of broadcast information in any cellular systems is to set up channels for communication between the UE and the gNB. This is generally referred to as paging. Paging is a procedure the wireless network uses to find out the location of a UE, before the actual connection establishment. Paging is used to alert the UE of an incoming session (call). In most cases, the paging process happens while UE is in radio resource control (RRC) idle mode. This means that UE has to monitor whether the networking is sending any paging message to it and it has to spend some energy to run this “monitoring” process. During RRC idle mode, a UE gets into and stays in sleeping mode defined in discontinuous reception (DRX) cycle. UE periodically wakes up and monitors PDCCH to check for the presence of a paging message. If the PDCCH indicates that a paging message is transmitted in a subframe, then the UE demodulates the paging channel to see if the paging message is directed to it.

In NR, paging reception consumes less than 2.5% of the total power. However, due to synchronization signal block (SSB) transmission scheme in NR, LOOP operations (including AGC, FTL, and TTL) and measurements (MEAS) can only be performed in certain occasions. As a result, there is some gap between the SSBs for LOOP/MEAS and paging occasion (PO), and UE may enter light sleep mode in the gap. A paging early indication (PEI) is introduced for power consumption enhancements in a 5G/NR network. PEI is provided to UE before paging and UE monitors PO only if paging is indicated by the PEI. As a result, UE can save power consumption not only for paging reception, but also for the light sleep between the last SSB and PO gap. Note that in light sleep mode, UE does not fully turn of its receiver, and thus the power consumption is higher than that in deep sleep mode, but lower than normal mode. Compared to deep sleep mode, light sleep mode requires less transition power to/from normal mode.

FIG. 1 depicts the SSB transmission scheme in NR, where LOOP operations (including AGC, FTL, and TTL) and measurements (MEAS) can only be performed in certain occasions, e.g., during SSB bursts. UE wakes up for SSBs, e.g., every 20 ms (every 2 radio frames). UE may enter light sleep mode in the gap between the SSBs for LOOP/MEAS and paging occasion (PO). Note that Low-SINR UEs need to wake up earlier, i.e., monitor more SSB bursts (larger NssB) before being able to decode paging message. High-SINR UEs may wake up later before PO monitoring. Therefore, if there is only one PEI for each PO, PEI needs to be relatively early in order to cover a wide range of SINR values since a PEI serves many UEs.

When PEI is introduced, UE can skip PO monitoring if PEI indicates negative, e.g., entering deep sleep in the gap between PEI and PO. The UE main receiver is turned on in every paging cycle, for LOOP, MEAS, and PEI reception. If PEI indicates no paging, then after performing required measurements, UE can turn off its main receiver and go to deep sleep until the next PEI. Note that UE is required to perform intra- or inter-frequency measurements when the serving cell is below certain threshold. Usually UE performs the required measurements when it wakes up for paging monitoring (i.e., every paging cycle), then UE will stay in deep sleep until next PEI. Since PEIs are always transmitted and are located near SSB bursts, power saving can be achieved not only for PO monitoring but also for light sleep between the last SSB/PEI and the PO monitoring gap and state transitions (e.g., the power mode transition from/to normal mode to/from light sleep mode), when no UE in the UE group is paged.

In accordance with one novel aspect, UE subgrouping is used to indicate whether some UEs (a subgroup) among those UEs monitoring the same paging occasion needs to read paging. The UE subgroup can be grouped based on different criteria, e.g., power consumption profiled (PCP), or paging probability. The UE subgroup has a reduced number of UEs, with a reduced false alarm rate for paging, at thus a reduced power consumption. In one preferred embodiment, the PEI contains a bitmap, each bit indicates if a subgroup of UEs monitoring the same PO needs to read paging. In the example of FIG. 1, 110 represents a group of UEs monitoring the same PO, and 120 represents a subgroup of UEs within UE group 110. PEI 130 is located next to the SSB burst 131, and PEI 130 contains a bitmap, e.g., a bit “0” indicates a corresponding UE subgroup has no paging, those UEs can enter deep sleep in 132; and a bit “1” indicates a corresponding UE subgroup needs to read paging in the upcoming PO.

FIG. 2 is a simplified block diagram of wireless devices 201 and 211 in accordance with embodiments of the present invention. For wireless device 201 (e.g., a base station), antennae 207 and 208 transmit and receive radio signal. RF transceiver module 206, coupled with the antennae, receives RF signals from the antennae, converts them to baseband signals and sends them to processor 203. RF transceiver 206 also converts received baseband signals from the processor, converts them to RF signals, and sends out to antennae 207 and 208. Processor 203 processes the received baseband signals and invokes different functional modules and circuits to perform features in wireless device 201. Memory 202 stores program instructions and data 210 to control the operations of device 201.

Similarly, for wireless device 211 (e.g., a user equipment), antennae 217 and 218 transmit and receive RF signals. RF transceiver module 216, coupled with the antennae, receives RF signals from the antennae, converts them to baseband signals and sends them to processor 213. The RF transceiver 216 also converts received baseband signals from the processor, converts them to RF signals, and sends out to antennae 217 and 218. Processor 213 processes the received baseband signals and invokes different functional modules and circuits to perform features in wireless device 211. Memory 212 stores program instructions and data 220 to control the operations of the wireless device 211.

The wireless devices 201 and 211 also include several functional modules and circuits that can be implemented and configured to perform embodiments of the present invention. In the example of FIG. 2, wireless device 201 is a base station that includes an RRC connection handling module 205, a scheduler 204, a paging and mobility management module 209, and a control and configuration circuit 221. Wireless device 211 is a UE that includes a connection handling module 215, a registration module 214, a paging and mobility handling module 219, and a control and configuration circuit 231. Note that a wireless device may be both a transmitting device and a receiving device. The different functional modules and circuits can be implemented and configured by software, firmware, hardware, and any combination thereof. The function modules and circuits, when executed by the processors 203 and 213 (e.g., via executing program codes 210 and 220), allow base station 201 and UE 211 to perform embodiments of the present invention.

In one example, the base station 201 establishes an RRC connection with the UE 211 via RRC connection handling circuit 205, schedules downlink and uplink transmission for UEs via scheduler 204, performs paging, mobility, and handover management via mobility management module 209, and provides PEI, paging, measurement, and measurement reporting configuration information to UEs via configuration circuit 221. The UE 211 performs registration with the network via registration module 214, handles RRC connection via RRC connection handling circuit 215, performs PEI and paging monitoring and mobility via paging and mobility handling module 219, and obtains configuration information via control and configuration circuit 231. In one novel aspect, UE 211 receives paging configuration for PEI and monitors PEI, which indicates whether UE subgroups have paging. UE 211 can skip PO monitoring if PEI indicates negative to achieve power saving for PO monitoring and between the PEI and the PO monitoring gap.

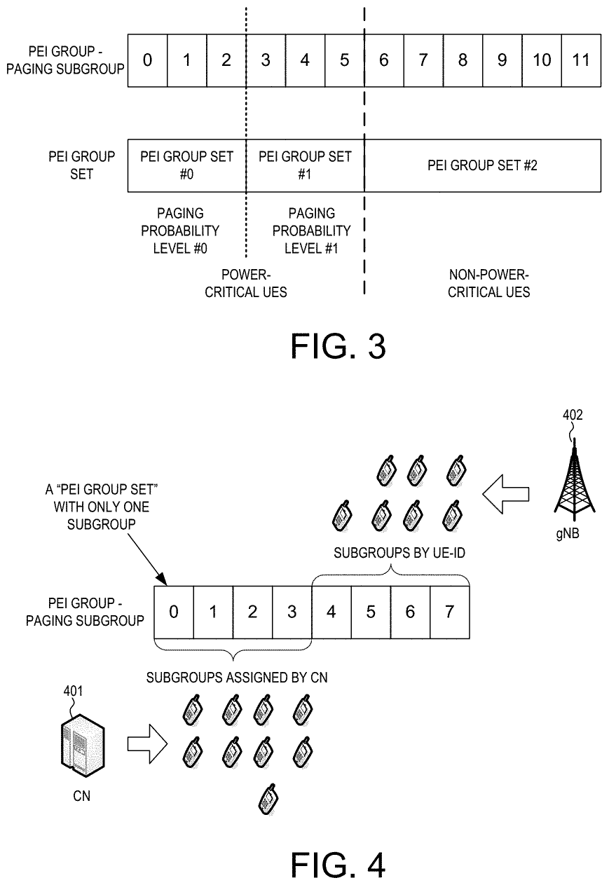

FIG. 3 illustrates the concept of providing PEI for UE paging subgrouping for idle-mode power saving in accordance with one novel aspect. A two-step approach is adopted for UE paging subgrouping. In a first step, the network assigns PEI group sets to PEI groups, each PEI group set contains a selected number of PEI groups, which are also referred to as paging subgroups. In a second step, UE-ID (hashing) based subgroup selection is applied. A number of subgrouping factors, e.g., power consumption profile and paging probability, can be used for assigning PEI group sets. Multiple factors can be considered for subgrouping, and different factors can be considered in different PEI group sets.

In the example of FIG. 3, there are twelve (12) PEI groups monitoring the same PO. In the first step, the twelve PEI groups are divided into three PEI group sets. PEI groups 0-2 belong to PEI group set #0 (power-critical, paging probability level #0), PEI groups 3-4 belong to PEI group set #1 power-critical, paging probability level #1), and PEI groups 6-11 belong to PEI group set #3 (non-power-critical). Note that not every factor needs to be considered in each PEI group set, but more than two factors are allowed for UE subgrouping. In one example, for power-critical UEs, UE grouping is based on two levels of paging probability. For non-power-critical UEs, UE grouping based on paging probability is not considered. In the second step, UE-ID is then used for PEI group selection, e.g., UE selects its paging subgroup from the assigned PEI group set# using UE-ID (hashing). The parameters need to be configured include: 1) total number of PEI groups; 2) the number of PEI groups for each PEI group set; 3) the thresholds for paging probability levels; 4) the list of factors considered; and 5) the factors for a PEI group set, in the format of tuples, the size depends on the number of factors for UE paging subgrouping.

FIG. 4 illustrates a preferred embodiment of providing PEI for UE paging subgrouping for idle-mode power saving in accordance with one novel aspect. In the embodiment of FIG. 4, UE paging subgrouping can be assigned by the core network (CN) directly, or selected based on UE-ID (hashing) based subgrouping. If both methods can co-exist in a cell, a UE may 1) be assigned with a paging subgroup ID directly from CN 401; and 2) calculate its paging subgroup ID based on its UE-ID assigned by its serving base station gNB 402. For example, there are total eight (8) PEI groups monitoring the same PO. CN 401 assigns paging subgroups with PEI group IDs #0-#3 to some UEs (e.g., power-critical UEs). This is equivalent to having four “PEI group sets”, each PEI group set having only one PEI group/paging subgroup. For UEs without CN-assigned paging subgroup ID (e.g., non-power-critical UEs), then each UE selects its paging subgroup from PEI groups #4-#7 based on UE-ID.

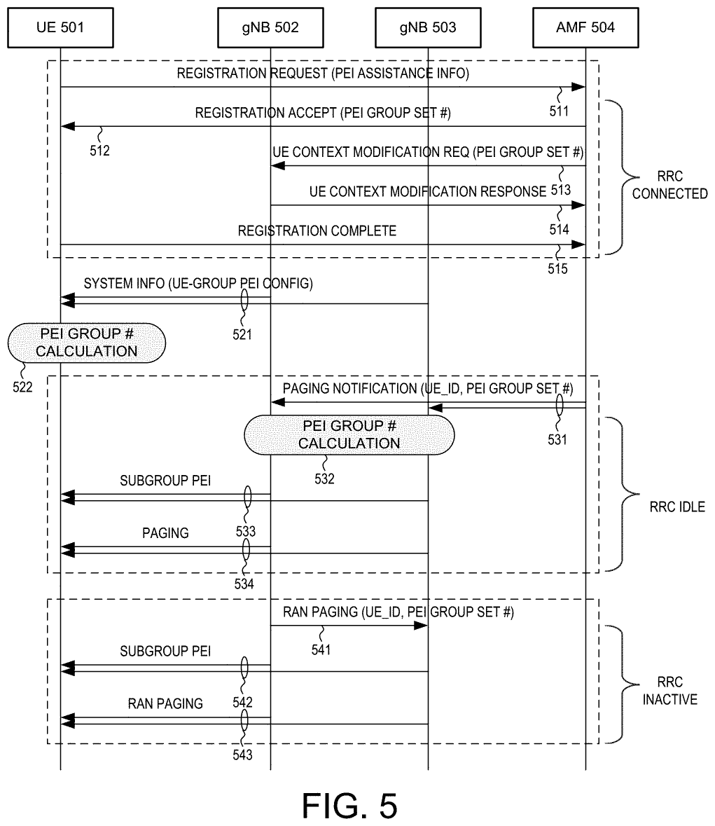

FIG. 5 illustrates a sequence flow between a UE and network entities supporting a first embodiment of UE paging subgrouping using PEI. The first embodiment of FIG. 5 corresponds to the two-step approach illustrated in FIG. 3. In step 511, UE 501 sends a registration request message to AMF 504. The registration request message comprises PEI assistance information, which further comprises UE capability such as the minimum required gap between PO and corresponding PEI. In step 512, UE 501 receives a registration accept message from AMF 504. The registration accept message comprises PEI group set ID# assigned to the UE. In step 513, AMF 504 sends a UE context modification request message to serving base station gNB 502, with PEI group set assignments. In step 514, gNB 502 sends a UE context modification response message to AMF 504. In step 515, UE 501 sends a registration complete message to AMF 504.

UE 501 may enter RRC idle state at a later time. In step 521, UE 501 receives system information containing UE-group PEI configuration from gNB 502 and gNB 503, e.g., via broadcasting. The PEI configuration indicates whether and where the network sends PEI and paging messages. For example, the paging configuration indicates a PEI offset value associated with a corresponding paging frame (PF). In step 522, UE 501 calculates its PEI group/paging subgroup. For example, UE 501 can derive its paging subgroup based on the assigned PEI group set ID# and its UE-ID. In step 531, AMF 504 sends out paging notification to gNB 502 and gNB 503. The paging notification includes UE-ID and PEI group set ID# to be paged. In step 532, gNB 502 and gNB 503 calculate the PEI group/paging subgroup to be paged. In step 533, gNB 502 and gNB 503 provide PEI for UE paging subgroups in a PEI-carrying radio frame. UE 501 determines the radio frame that carries PEI, and determines the starting point and duration of PEI monitoring based on PEI configuration. Upon PEI monitoring, UE 501 also determines whether the PEI indicates positive paging for the paging subgroup that UE 501 belongs to. In step 534, gNB 502 and gNB 503 forwards the paging notification in a paging frame to a group of UEs including UE 501. UE 501 goes to deep sleep during the gap from PEI to PO, if the PEI indicates negative paging. UE 501 monitors PO and decodes the paging message inside, if the PEI indicates positive paging. Steps 541-543 are RAN paging for RRC inactive state.

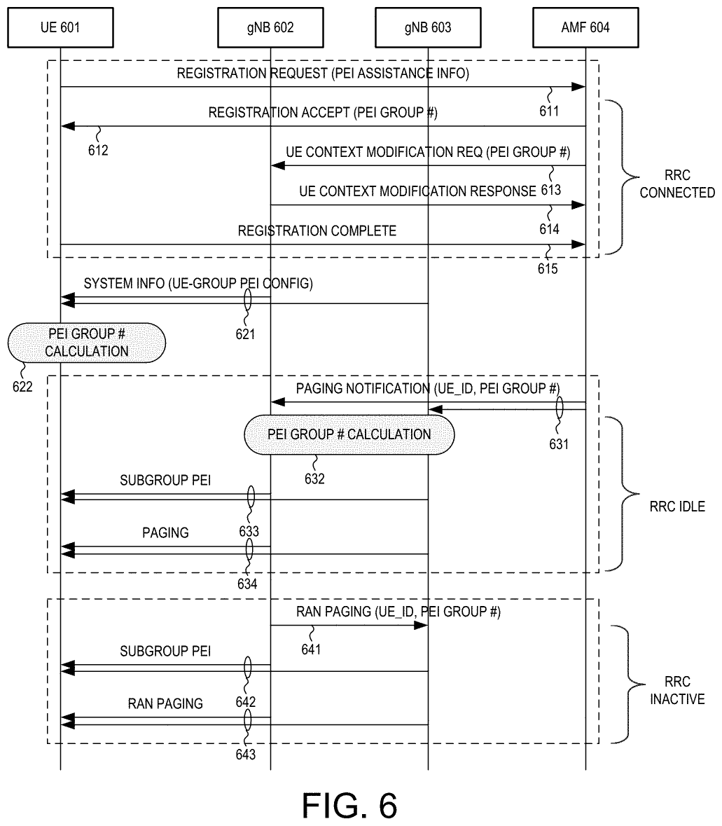

FIG. 6 illustrates a sequence flow between a UE and network entities supporting a second embodiment of UE paging subgrouping using PEI. The second embodiment of FIG. 6 corresponds to the embodiment illustrated in FIG. 4. Steps 611-643 are similar to steps 511-543 of the first embodiment in FIG. 5. However, in step 612, in the registration accept message, instead of providing PEI group set assignment to UE, the network optionally provides PEI group#, e.g., paging subgroup assignment directly. In this way, in step 622, UE 601 may 1) be assigned with a paging subgroup ID directly from AMF 604 (e.g., for power-critical UEs); and 2) calculate its paging subgroup ID based on its UE-ID (if PEI group# is not provided, e.g., for non-power-critical UEs). The second embodiment of FIG. 6 can also be viewed as a special case of the first embodiment of FIG. 5. In other words, each assigned PEI group can be viewed as an assigned PEI group set, having only one PEI group member.

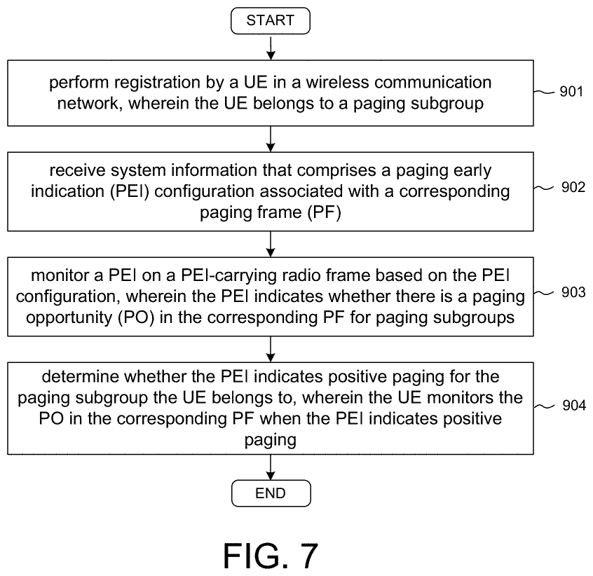

FIG. 7 is a flow chart of a method of UE paging subgrouping for power consumption enhancements in a 5G/NR network in accordance with one novel aspect of the present invention. In step 701, a UE performs registration in a wireless communication network. The UE belongs to a paging subgroup. In step 702, the UE receives system information that comprises a paging early indication (PEI) configuration associated with a corresponding paging frame (PF). In step 703, the UE monitors a PEI on a PEI-carrying radio frame based on the PEI configuration. The PEI indicates whether there is a paging opportunity (PO) in the corresponding PF for paging subgroups. In step 704, the UE determines whether the PEI indicates positive paging for the paging subgroup that the UE belongs to. The UE monitors the PO in the corresponding PF when the PEI indicates positive paging.

Although the present invention is described above in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
performing registration by a user equipment (UE) in a wireless communication network, wherein the UE belongs to a paging subgroup;
receiving system information that comprises a paging early indication (PEI) configuration associated with a corresponding paging frame (PF);
monitoring a PEI on a PEI-carrying radio frame based on the PEI configuration, wherein the PEI indicates whether there is a paging opportunity (PO) in the corresponding PF for paging subgroups; and
determining whether the PEI indicates positive paging for the paging subgroup the UE belongs to, wherein the UE monitors the PO in the corresponding PF when the PEI indicates positive paging.

2. The method of claim 1, wherein each paging subgroup has a paging subgroup ID and belongs to a group of UEs that monitoring a same PO.

3. The method of claim 2, wherein the UE receives a registration accept message from the network that provides a paging subgroup ID to the UE.

4. The method of claim 2, wherein the UE is provided with a PEI group set ID of a PEI group set that the UE belongs to, and wherein each PEI group set comprises one or more paging subgroups.

5. The method of claim 4, wherein the UE derives a paging subgroup ID from the PEI group set based on a UE ID.

6. The method of claim 2, wherein the UE derives a paging subgroup ID based on a UE ID when the paging subgroup ID is not provided by the network.

7. The method of claim 1, wherein a list of factors including a power consumption profile (PCP) and a paging probability is considered for subgrouping.

8. The method of claim 1, wherein the PEI is a bitmap in a downlink control information (DCI), and wherein each bit indicates positive or negative paging for a corresponding paging subgroup.

9. The method of claim 1, wherein the UE goes to deep sleep from the reception of the PEI to the corresponding PF when the PEI indicates negative paging.

10. The method of claim 9, wherein the UE turns off a main radio frequency (RF) receiver during the deep sleep without waking up to monitor any PO.

11. A user equipment (UE), comprising:
a registration circuit that performs registration in a wireless communication network, wherein the UE belongs to a paging subgroup;
a receiver that receives system information that comprises a paging early indication (PEI) configuration associated with a corresponding paging frame (PF);
a paging handling circuit that monitors a PEI on a PEI-carrying radio frame based on the PEI configuration, wherein the PEI indicates whether there is a paging opportunity (PO) in the corresponding PF for paging subgroups; and
a control circuit that determines whether the PEI indicates positive paging for the paging subgroup the UE belongs to, wherein the UE monitors the PO in the corresponding PF when the PEI indicates positive paging.

12. The UE of claim 11, wherein the paging subgroup has a paging subgroup ID and belongs to a group of UEs that monitoring a same PO.

13. The UE of claim 12, wherein the UE receives a registration accept message from the network that provides a paging subgroup ID to the UE.

14. The UE of claim 12, wherein the UE is provided with a PEI group set ID of a PEI group set that the UE belongs to, and wherein each PEI group set comprises one or more paging subgroups.

15. The UE of claim 14, wherein the UE derives a paging subgroup ID from the PEI group set based on a UE ID.

16. The UE of claim 12, wherein the UE derives a paging subgroup ID based on a UE ID when the paging subgroup ID is not provided by the network.

17. The UE of claim 11, wherein a list of factors including a power consumption profile (PCP) and a paging probability is considered for subgrouping.

18. The UE of claim 11, wherein the PEI is a bitmap in a downlink control information (DCI), and wherein each bit indicates positive or negative paging for a corresponding paging subgroup.

19. The UE of claim 11, wherein the UE goes to deep sleep from the reception of the PEI to the corresponding PF when the PEI indicates negative paging.

20. The UE of claim 9, wherein the UE turns off a main radio frequency (RF) receiver during the deep sleep without waking up to monitor any PO.
